(19) United States
(12) Patent Application Publication
(10) Pub. No.: US 2014/0009487 A1
(43) Pub. Date: Jan. 9, 2014

(54) IMAGE PROCESSING DEVICE AND IMAGE DISPLAY DEVICE HAVING REDUCED BUS LOAD, AND RELATED METHODS

(71) Applicant: KABUSHIKI KAISHA TOSHIBA, Tokyo (JP)

(72) Inventor: Hideaki MIZUNO, Kanagawa (JP)

(73) Assignee: Kabushiki Kaisha Toshiba, Tokyo (JP)

(21) Appl. No.: 13/784,742

(22) Filed: Mar. 4, 2013

(30) Foreign Application Priority Data
Jul. 5, 2012 (JP) 2012-151697

(51) Int. Cl. G06T 1/60

(52) U.S. Cl. CPC G06T 1/60
USPC 345/592

(57) ABSTRACT

According to embodiments, an image processing device is disclosed. The image processing device comprises a memory unit configured to store a foreground image data and a background image data, a data transfer unit configured to transmit image data from the memory unit, and an image data processing unit configured to process image data. The image data processing unit comprises a subsampling designation unit configured to instruct the memory section to transmit over the data transfer unit a subsampled image data, the subsampled image data being subsampled from the background image data stored in the memory unit. The image data processing unit further comprises a transparency processing unit configured to perform transparency processing on the foreground image data to form a transparent image data.

### CROSS-REFERENCE TO RELATED APPLICATION

This application is based upon and claims the benefit of priority from Japanese Patent Application No. 2012-151697, filed Jul. 5, 2012, the entire contents of which are incorporated herein by reference.

### FIELD

Embodiments described herein relate generally to an image processing device that processes image data and an image display device for displaying images. In particular, the embodiments relate to an image processing device having a reduced load on a data transfer bus.

### BACKGROUND

Conventionally, an image processing device performs image processing in order to overlay a foreground image on a background image. This type of image processing device includes a memory, a data transfer bus, and an image integration processing unit. Foreground image data and background image data placed in the memory are transferred to the image integration processing unit via the data transfer bus. The transferred data for a plurality of images is integrated by the image integration processing unit. However, the high load on the data transfer bus is a problem for a conventional image processing device.

### DESCRIPTION OF THE DRAWINGS

FIG. 1 is a block diagram showing an image processing device according to a first embodiment.

FIG. 2 is a block diagram showing an image processing device according to a second embodiment.

FIG. 3 is a block diagram showing an image processing device according to a third embodiment.

FIG. 4 is a block diagram showing an image display device according to a fourth embodiment.

### DETAILED DESCRIPTION

Embodiments provide an image processing device and an image display device that are able to reduce the load on a data transfer bus.

In general, the embodiments are explained with reference to the drawings.

An image processing device according to an embodiment comprises a memory unit configured to store a foreground image data and a background image data, a data transfer unit configured to transmit image data from the memory unit, and an image data processing unit configured to process image data. The image data processing unit comprises a subsampling designation unit configured to instruct the memory section to transmit subsampled image data over the data transfer unit, the subsampled image data being subsampled from the background image data stored in the memory unit. The image data processing unit further comprises a transparency processing unit configured to perform transparency processing on the foreground image data to form transparent image data.

An image processing method according to an embodiment includes storing a foreground image data and a background image data in a memory unit, determining a transparency rate for the foreground image data, comparing the determined transparency rate to a standard transparency rate, and instructing the memory unit to transmit subsampled image data over a data bus based on the comparison, wherein the subsampled image data is subsampled from at least one of the foreground imaged data and the background image data.

### First Embodiment

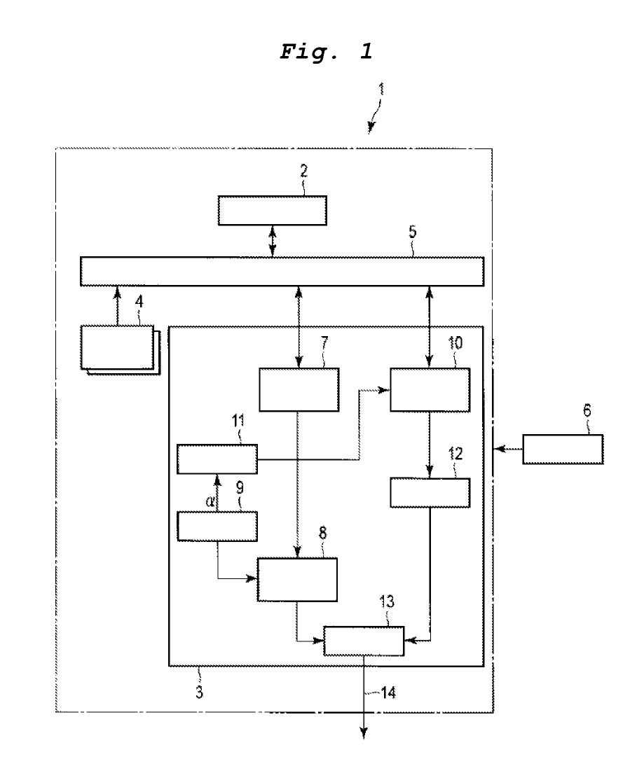

FIG. 1 is a block diagram showing an image processing device according to the first embodiment.

In the first embodiment, an image processing device 1 includes a memory device 2, an image data processing unit 3, an image input unit 4, a data transfer bus 5, and a control section 6.

The memory device 2 stores data including foreground image data and background image data. For example, the background image data may be map data, and the foreground image data may be an arrow that is to be superimposed on the map. The memory device 2 may be, for example, a DRAM.

The image data processing unit 3 processes image data in order to superimpose a foreground image on a background image. A detailed explanation of the image data processing unit 3 is given further below.

Image data intended for storage in the memory device 2 is input into the image input unit 4. For example, when the image processing device is applied to a vehicle navigation device, certain image data is input into the image input unit 4. This image data can be, for example, map-related data, data pertaining to an arrow indicating the direction to a destination, data pertaining to marks showing the present location, and/or data pertaining to traffic congestion.

As another example, the image processing device may be applied to an image display device for a vehicle in which a plurality of cameras are mounted on a vehicle. The images captured by the plurality of cameras are integrated so that images of the vehicle and its surroundings can be displayed. Image data captured by the plurality of cameras, for example, is input into the image input unit 4.

As another example, the image processing device of this embodiment may be applied to a data processing device, such as a computer. Image data pertaining to overlapping windows, for example, is input into the image input unit 4.

Note that the image processing device 1 does not require the image input unit 4. A device corresponding to the image input unit 4 can be provided outside of the image processing device 1.

The data transfer bus 5 is a memory transfer path comprised of a bus for transferring image data from the image input unit 4 to the memory device 2 and for transferring image data stored in the memory device 2 to the image data processing unit 3. Other data besides image data maybe transferred over the data transfer bus 5.

The control section 6 functions as a control center that has overall control of the device. The control section 6 controls the memory device 2, the image data processing unit 3, the image input unit 4, and the data transfer bus 5, according to a program.

The image data processing unit 3 includes a foreground image data receiving unit 7 that is configured to receive foreground image data via the data transfer bus 5 from the memory device 2. The foreground image data receiving unit 7 can send instructions to the memory device 2 via the data transfer bus 5. For example, the foreground image data receiving unit 7 can instruct the memory device 2 to transfer foreground image data over the data transfer bus 5 in order to receive foreground image data. According to the first embodiment, the foreground image data is transmitted to the data transfer bus 5 without subsampling.

The image data processing unit 3 includes a foreground image transparency processing unit 8 for transparency processing the foreground image data received by the foreground image data receiving unit 7. The image data processing unit 3 also includes a transparency determination unit 9 for determining the transparency rate for the transparency processing.

The transparency determination unit 9 determines a transparency rate (received, for example, as a table) corresponding to the foreground image. The foreground image transparency processing unit 8 performs transparency processing on the foreground image data, based upon the transparency rate that has been input from the transparency determination unit 9. Foreground image data that has undergone transparency processing is then sent to an image data integration unit 13.

According to another embodiment, rather than determining the transparency based on a table, the transparency determination unit 9 can determine the transparency rate by performing a calculation.

The image data processing unit 3 further includes a background image data receiving unit 10 for receiving background image data from the memory device 2 via the data transfer bus 5. In order to receive the background image data, the background image data receiving unit 10 sends instructions to the memory device 2 via the data transfer bus 5. Based on the instructions, the memory device 2 sends the background image data to the data transfer bus 5.

The image data processing unit 3 further includes a subsampling designation unit 11 for sending instructions to the memory device 2 via the data transfer bus 5, to indicate that subsampled background image data is to be sent from the memory device 2 over the data transfer bus 5.

Specifically, the subsampling designation unit 11 provides instructions to the memory device 2, via the background image data receiving unit 10 and the data transfer bus 5, regarding a subsampling rate corresponding to the transparency rate (determined transparency rate α) determined by the transparency determination unit 9. Alternatively, the memory device 2 can receive instructions from the subsampling designation unit 11 via the data transfer bus 5 and without the background image data receiving unit 10.

For example, the subsampling designation unit 11 compares a determined transparency rate α to a standard transparency rate α₀. Based on the comparison, the subsampling designation unit 11 designates a subsampling rate that differs in a case where α<α₀ and a case where α≧α₀. The designated subsampling rate in a case where α<α₀ is higher than the designated subsampling rate in a case where α≧α₀. In other words, in a case where the foreground image transparency rate is smaller than a predefined constant value, the background image will be hidden by the foreground image and will be less conspicuous. In such a case, the rate for subsampling the background image data is increased. As an example where background image data is subsampled, the background image may be composed of a plurality of continuous pixels, and one or the other of two contiguous pixels is not sent.

It is also acceptable to have a plurality of standard transparency rates. For example, it is acceptable for there to be three standard transparency rates: a standard transparency rate α₁, a standard transparency rate α₂, and a standard transparency rate α₃, such that α₁<α₂<α₃. A subsampling rate D₁ is designated for cases in which α₁<α≦α₂. A subsampling rate D₂ is designated for cases in which α₂<α≦α₃. A subsampling rate D3 is designated for cases in which α>α₃. The magnitude relationship between D₁, D₂, and D₃ may be, for example, D₁>D₂>D₃. Generally, the lower the transparency rate of a foreground image, the higher the subsampling rate may be designated for background image data.

The subsampling designation unit 11 may be incorporated within the background image data receiving unit 10.

Having received subsampling instructions from the subsampling designation unit 11, the memory device 2 sends the subsampled background image data to the data transfer bus 5. The subsampled background image data has a smaller data volume than the original background image data stored in the memory device 2. Thus, the subsampled background data, and not the original background image data, is sent to the data transfer bus 5. In this manner, the load on the data transfer bus 5 is reduced.

The subsampled background image data is received by the background image data receiving unit 10 and is then sent to the supplement processing unit 12. The supplement processing unit 12 performs supplementation processing on the subsampled background image data, restoring it to the same size as the original background image data.

The supplement processing unit 12 restores the subsampled background image data to the same size as the original background image data by, for example, interpolation. For example, in a case of subsampling where only one of two adjacent pixels has been sent, the untransmitted pixel is interpolated based upon two adjacent pixels that actually were transmitted. The subsampled background image data that has undergone supplemental (e.g., interpolation) processing by the supplement processing unit 12 is then sent to the image data integration unit 13.

In the image data integration unit 13, foreground image data that has undergone transparency processing and subsampled background image data that has undergone supplemental (e.g., interpolation) processing is integrated to generate integration image data 14.

The integration image data 14 corresponds to images where a foreground image corresponding to foreground image data is superimposed upon a background image corresponding to background image data. In a case where the transparency rate is low for the foreground image data, the background image corresponding to the background image data is hidden in the background image and becomes inconspicuous. Therefore, if background image data is subjected to subsampling and then sent, the influence on the appearance of the background image is small, and it is possible to maintain an acceptable image quality. By subsampling the background image data and reducing the transmission volume, the load on the data transfer bus 5 is reduced, and the access volume on the memory device 2 can also be reduced.

### Second Embodiment

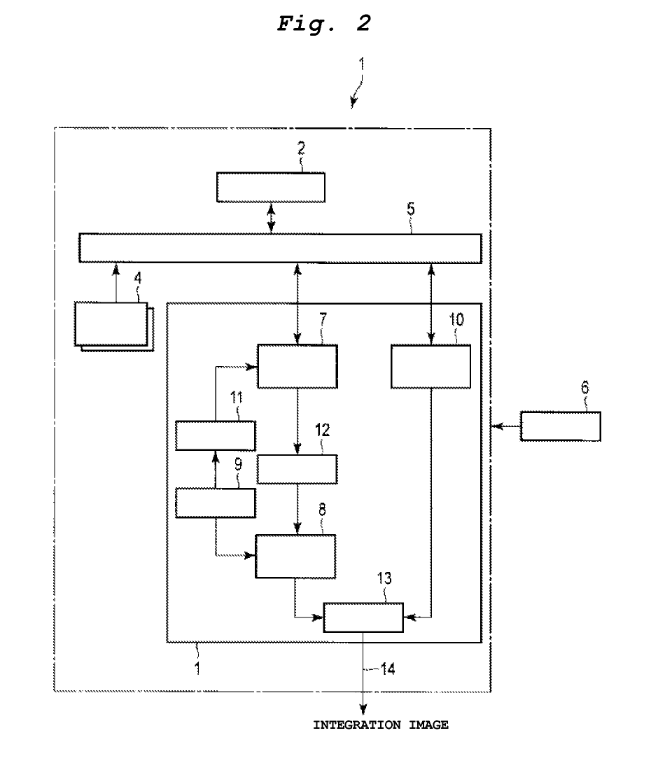

FIG. 2 is a block diagram showing an image processing device according to the second embodiment.

Note that the parts that correspond with FIG. 1 have been assigned identical symbols as in FIG. 1, so a detailed explanation of them is unnecessary and has been omitted.

In the image processing device of the first embodiment, the background image data is subjected to subsampling. However, in the image processing device of the present embodiment, it is the foreground image data that is subjected to subsampling.

Accordingly, according to the second embodiment, a subsampling designation unit 11 sends subsampling instructions to the memory device 2 via the foreground image data receiving unit 7 and the data transfer bus 5. Based on the instructions, subsampled foreground image data is sent from the memory device 2 to the data transfer bus 5. Alternatively, the memory device 2 can receive instructions via the data transfer bus 5 and without the foreground image data receiving unit 7.

More specifically, the subsampling designation unit 11 designates a subsampling rate for the foreground image data based on the transparency rate (determined transparency rate α) determined by the transparency determination unit 9.

For example, the subsampling designation unit 11 compares a determined transparency rate α and a standard transparency rate α₀, and it designates a subsampling rate that differs in the case where α<α₀ compared to the case where α≧α₀. For example, a designated subsampling rate in a case where α≧α₀ is higher than a designated subsampling rate in a case where α<α₀. In other words, in a case where the foreground image transparency rate is higher than a constant value, the foreground image will be influenced by the background image and become less conspicuous. In such a case, the rate for subsampling the foreground image data is increased. In other cases, the failure of foreground image to be conspicuous does not change significantly.

It is also acceptable for the subsampling designation unit 11 to designate a subsampling rate for foreground image data according to the type of foreground image. For example, in a case where the foreground image is a marker (i.e., a location marker) indicating the current location, the location marker is easily restored by supplemental processing. In such cases, the foreground image, is not very susceptible to being influenced by the background image, and, therefore, can have a high subsampling rate designated.

It is also acceptable for the subsampling designation unit 11 to be incorporated into the foreground image data receiving unit 7.

The memory device 2, having received subsampling instructions from the subsampling designation unit 11, sends subsampled foreground image data to the data transfer bus 5. Because the subsampled foreground image data sent to the data transfer bus 5 has a smaller data volume compared to the original foreground image data stored in the memory device 2, the load on the data transfer bus 5 is reduced.

The subsampled foreground image data received by the foreground image data receiving unit 7 is then sent to the supplemental processing unit 12. The supplemental processing unit 12 performs supplemental processing (e.ge., interpolation processing) to restore the subsampled foreground image data to the same size as the original foreground image data.

The subsampled foreground image data that has undergone supplemental (e.g., interpolation) processing by supplemental processing unit 12 is then sent to the image data integration unit 13. The image data integration unit 13 generates integration image data 14 by integrating subsampled foreground image data that has undergone supplemental processing and transparency processing with background image data (e.g., scenic image data) that has not undergone subsampling.

According to the present embodiment, the foreground image data transmission volume is reduced, which reduces the load on the data transfer bus 5 and reduces the access volume on the memory device 2.

### Third Embodiment

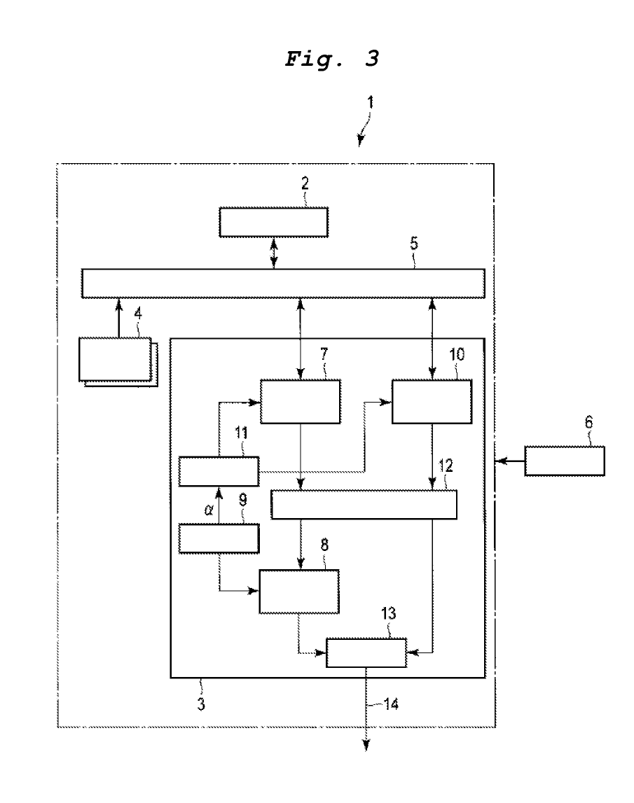

FIG. 3 is a block diagram showing an image processing device according to the third embodiment.

Note that the parts that correspond with FIG. 1 and FIG. 2 have been assigned identical symbols as in FIG. 1 and FIG. 2, so a detailed explanation of them is unnecessary and has been omitted.

This embodiment differs from the first embodiment and the second embodiment in that both the background image data and the foreground image data are subjected to subsampling. Similar to the first embodiment, the background image data is subsampled, and similar to the second embodiment the foreground image data is subsampled. Thus, the subsampling designation unit sends subsampling instructions to the memory unit 2 via the data transfer bus 5 and the foreground and background receiving units 7 and 10. The subsampled foreground image data is then sent over the data transfer bus 5 and received in the foreground receiving unit 7. Likewise, the subsampled background image data is then sent over the data transfer bus 5 and received in the background receiving unit 10.

By subjecting both the background image data and the foreground image data to subsampling, the performance of an image processing device can be improved, particularly with respect to the data volume passing over the data transfer bus 5. This works advantageously for the utilization of an image processing device.

Alternatively, the embodiment of FIG. 3 allows for additional flexibility in image processing. For example, based on a comparison of the transparency rate α to a standard transparency rate α₀ for a given image processing procedure, the subsampling designation unit 11 may instruct the memory unit to transmit over the data transfer bus 5 subsampled foreground image data or subsampled background image data. For example, the subsampling designation unit 11 compares a determined transparency rate α and a standard transparency rate α₀. In the case where α<α₀, the subsampling designation unit 11 may instruct the memory unit to transmit over the data transfer bus 5 subsampled background image data. the compared to the case where α≧α₀. In a case where α≧α₀, the subsampling designation unit 11 may instruct the memory unit to transmit over the data transfer bus 5 subsampled foreground image data. In other words, in a case where the foreground image transparency rate is higher than a constant value, the background image will dominate and the foreground image will become less conspicuous. In such a case, the foreground image is subsampled. In a case where the foreground image transparency rate is lower than a constant value, the foreground image will dominate, and the background image will become less conspicuous. In such a case, the background image is subsampled.

### Fourth Embodiment

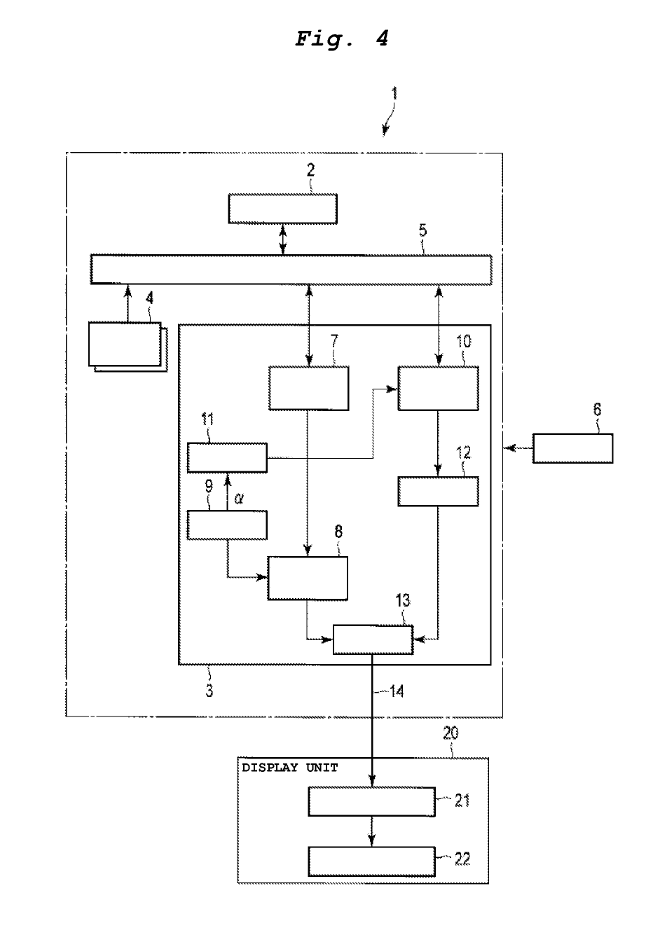

FIG. 4 is a block diagram showing an image display device according to the fourth embodiment.

The image display device of the present embodiment includes the image processing device 1 of the first embodiment. It is also furnished with a display unit 20 for displaying images in which a foreground image and a background image have been superimposed, based upon the integration image data 14 generated by the image processing device 1.

The display unit 20 is provided with a display driver 21 that includes video buffer memory into which the integration image data 14 is written. The display unit 20 also includes a display 22, which may be a liquid crystal display, or an organo-EL (Electroluminescent) display, for example. The display driver 21 displays the images on the display 22, based upon the integration image data 14 that has been read into the video buffer memory.

It is also contemplated that the image processing device 1 of the second embodiment and the third embodiment can be used in place of the image processing device 1 of the first embodiment in connection with the display unit 20 of the fourth embodiment.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, comprising:
a memory unit configured to store foreground image data and background image data;
a data transfer unit configured to transmit image data from the memory unit; and
an image data processing unit configured to process image data, the image data processing unit including a subsampling designation unit configured to instruct the memory unit to transmit subsampled image data over the data transfer unit, the subsampled image data being subsampled from the background image data stored in the memory unit, and a transparency processing unit configured to perform transparency processing on the foreground image data to form transparent image data.

2. The image processing device according to claim 1, wherein
the transparency processing unit performs the transparency processing based upon a transparency rate; and
the subsampled image data is subsampled at a subsampling rate that is determined based on the transparency rate.

3. The image processing device according to claim 1, further comprising:
a supplemental processing unit configured to interpolate the subsampled image data to form an interpolated background image substantially similar to the background image data stored in the memory unit; and
an image data integration unit configured to integrate the transparent image data and the interpolated image data to form an integrated image data.

4. The image processing device according to claim 3, further comprising a display unit configured to display the integrated image data.

5. The image processing device according to claim 1, further comprising an image data integration unit configured to integrate the transparent image data and the subsampled image data to form an integrated image data.

6. The image processing device according to claim 5, further comprising a display unit configured to display the integrated image data.

7. An image processing device, comprising:
a memory unit configured to store a foreground image data and a background image data;
a data transfer unit configured to transmit image data from the memory unit; and
an image data processing unit configured to process image data, the image data processing unit including a subsampling designation unit configured to instruct the memory section to transmit subsampled image data over the data transfer unit, the subsampled image data being subsampled from the foreground image data stored in the memory unit, and a transparency processing unit configured to perform transparency processing on the subsampled image data to form transparent image data.

8. The image processing device according to claim 7, wherein
the transparency processing unit performs the transparency processing based upon a transparency rate; and
the subsampled image data is subsampled at a subsampling rate that is determined based on the transparency rate.

9. The image processing device according to claim 7, further comprising:
a supplemental processing unit configured to interpolate the subsampled image data to form an interpolated foreground image substantially similar to the foreground image data stored in the memory unit; and
an image data integration unit configured to integrate the background image data and the interpolated image data to form an integrated image data.

10. The image processing device according to claim 9, further comprising a display unit configured to display the integrated image data.

11. The image processing device according to claim 7, further comprising an image data integration unit configured to integrate the transparent image data and the background image data to form an integrated image data.

12. The image processing device according to claim 11, further comprising a display unit configured to display the integrated image data.

13. A method of image processing comprising:
storing a foreground image data and a background image data in a memory unit;
determining a transparency rate for the foreground image data;
comparing the determined transparency rate to a standard transparency rate; and
based on the comparison, instructing the memory unit to transmit a subsampled image data that is subsampled from at least one of the foreground imaged data and the background image data over a data bus.

14. The method of image processing according to claim 13, wherein the subsampled image data is subsampled from at least one of the foreground imaged data and the background image data at a subsampling rate that is determined based on the comparison.

15. The method of image processing according to claim 13, wherein the subsampled image data comprises subsampled foreground image data that is subsampled from the foreground image data.

16. The method of image processing according to claim 13, wherein the subsampled image data comprises subsampled background image data that is subsampled from the background image data.

17. The method of image processing according to claim 16, further comprising:
interpolating the subsampled background image data; and
integrating the interpolated subsampled background image data with the foreground image data to form an integrated image data for display.

18. The method of image processing according to claim 13, wherein:
if the determined transparency rate is equal to or larger than the standard transparency rate, the subsampled image data is subsampled from the background image data, and
if the determined transparency rate is smaller than the standard transparency rate, then the subsampled image data is subsampled from the foreground image data.

19. The method of image processing according to claim 13, wherein the subsampled image data is subsampled from the background image data, and the method further comprises:
performing transparency processing on the foreground image data based on the transparency rate to form a transparent image data;
interpolating the subsampled image data to form an interpolated background image data that is substantially similar to the background image data; and
integrating the transparent image data and the interpolated background image data to form an integrated image data for display.

20. The method of image processing according to claim 13, wherein the subsampled image data is subsampled from the foreground image data, and the method further comprises:
performing transparency processing on the subsampled image data based on the transparency rate to form a transparent image data; and
integrating the transparent image data and the background image data to form an integrated image data for display.
